(19) United States
(12) Patent Application Publication
(10) Pub. No.: US 2009/0086750 A1
(43) Pub. Date: Apr. 2, 2009

(54) Non-Random Access Rapid I/O Endpoint In A Multi-Processor System

(75) Inventors: Chi-Lie Wang, Milpitas, CA (US); Jason Z. Mo, Fremont, CA (US); Stanley Hronik, Sunnyvale, CA (US); Jakob Saxtorph, San Jose, CA (US)

Correspondence Address: BEVER, HOFFMAN & HARMS, LLP, 1432 CONCANNON BLVD, BUILDING G, LIVERMORE, CA, 94550-6006, US

(73) Assignee: Integrated Device Technology, Inc., San Jose, CA (US)

(21) Appl. No.: 11/863,199

(22) Filed: Sep. 27, 2007

(51) Int. Cl. H04L 12/28

(52) U.S. Cl. 370/416

(57) ABSTRACT

A system and method for using a doorbell command to allow sRIO devices to operate as bus masters to retrieve data packets stored in a serial buffer, without requiring the SRIO devices to specify the sizes of the data packets. The serial buffer includes a plurality of queues that store data packets. A doorbell frame request packet identifies the queue to be accessed within the serial buffer, but does not specify the size of the data packet(s) to be retrieved. Upon detecting a doorbell frame request packet, the serial buffer operates as a bus master to transfer the requested data packets out of the selected queue. The selected queue can be configured to operate in a flush mode or a non-flush mode. The serial buffer may also indicate that a received doorbell frame request has attempted to access an empty queue.

### RELATED APPLICATIONS

The present application is related to the following commonly-owned, co-filed U.S. patent applications:

U.S. patent application Ser. No. ______ [Attorney Docket No. IDT-2275] “MULTI-FUNCTION QUEUE TO SUPPORT DATA OFFLOAD, PROTOCOL TRANSLATION AND PASS-THROUGH FIFO”, by Chi-Lie Wang, Jason Z. Mo and Mario Au.

U.S. patent application Ser. No. ______ [Attorney Docket No. IDT-2267] “SERIAL BUFFER SUPPORTING VIRTUAL QUEUE TO PHYSICAL MEMORY MAPPING”, by Chi-Lie Wang, Calvin Nguyen and Mario Au.

U.S. patent application Ser. No. ______ [Attorney Docket No. IDT-2276] “ADAPTIVE INTERRUPT ON SERIAL RAPIDIO (SRIO) ENDPOINT”, by Chi-Lie Wang, Jason Z. Mo, Bertan Tezcan.

### FIELD OF THE INVENTION

The present invention relates to a serial buffer designed to operate as a serial RapidIO (sRIO) end-point to provide data offload, protocol translation and pass-through FIFO functions. More specifically, the present invention relates to a serial buffer that allows multiple sRIO masters to read data packets having different sizes from the serial buffer.

### RELATED ART

FIG. 1A is a block diagram of a conventional sRIO system 100A, which includes serial buffer 101 and sRIO devices 102-104, which are commonly coupled to an sRIO bus 105. Serial buffer 101 can be used as a FIFO memory which stores data packets having different sizes. These different-sized data packets can be transferred from serial buffer 101 to any of sRIO devices 102-104 by configuring serial buffer 101 as a bus master. When serial buffer 101 is configured as a bus master, serial buffer 101 can transfer data packets from the FIFO memory to the desired sRIO device(s) on a packet-by-packet basis.

FIG. 1B is a block diagram of a conventional sRIO system 100B, which also includes serial buffer 101 and sRIO devices 102-104. In this sRIO system 100B, each of the multiple sRIO devices 102-104 is configured as a bus master, and serial buffer 101 is configured as a bus slave. In this configuration, each of the sRIO devices 102-104 can operate as a bus master to independently write one or more data packets to serial buffer 101 (which operates as a bus slave). Also in this configuration, each of the sRIO devices 102-104 can operate as a bus master to independently read one or more data packets from serial buffer 101 (which operates as a bus slave). However, in order for sRIO devices 102-104 to read data packets from serial buffer 101 in this manner, each of the sRIO devices 102-104 (as bus masters) must be able to specify the size of each data packet to be read from serial buffer 101 (as a bus slave). It will only be possible for sRIO devices 102-104 to accurately specify the size of each data packet to be read from serial buffer 101 if all of the data packets stored by serial buffer 101 are forced to have the same size. This is obviously an undesirable limitation to system 100. However, if different sized data packets are stored in serial buffer 101, it will not be possible for sRIO devices 102-104 to accurately specify the size of each data packet to be read from serial buffer 101. If any of sRIO devices 102-104 specifies a data packet size that is different than the actual size of the data packet stored in serial buffer 101, then the data read out of serial buffer 101 will not fall on the proper boundary of the data packet. For example, if the specified data packet size is smaller than the actual data packet size, then the data read from serial buffer 101 will be less than an entire data packet. Conversely, if the specified data packet size is larger than the actual data packet size, then the data read from serial buffer 101 will be more than one entire data packet. In either case, serial buffer 101 will malfunction.

It would therefore be desirable to have an sRIO system having multiple sRIO devices capable of operating as bus masters to retrieve variable size data packets from a serial buffer, without requiring the sRIO devices to specify the sizes of the data packets.

### SUMMARY

Accordingly, the present invention provides a system and method that uses a doorbell command to allow sRIO devices to operate as bus masters to retrieve data packets stored in a serial buffer, without requiring the SRIO devices to specify the sizes of the data packets. The serial buffer includes a plurality of queues, which are configured to store data packets. In accordance with the present invention, a queue to be accessed is initially configured as a slave device to accept a doorbell frame request from an sRIO device. The doorbell frame request identifies the queue to be accessed within the serial buffer, but does not specify the size of the data packet(s) to be retrieved. Upon detecting a doorbell frame request, the serial buffer operates as a bus master to transfer the requested data packets out of the selected queue. The selected queue can be configured to operate in a flush mode or a non-flush mode. If the selected queue is configured in the non-flush mode, then a single data packet is transferred out of the queue upon receiving a matching doorbell frame request. If the selected queue is configured in the flush mode, then all of the data packets that define a water level of the selected queue are transferred out of the queue when this water level exceeds a corresponding watermark of the queue. Finally, a ‘read exceed’ function can be implemented by the serial buffer, wherein the serial buffer generates a read exceed control signal to indicate that a received doorbell frame request has attempted to access an empty queue.

The present invention will be more fully understood in view of the following description and drawings.

### BRIEF DESCRIPTION OF THE DRAWINGS

FIGS. 1A and 1B are block diagrams of conventional sRIO systems, which include a serial buffer and multiple sRIO devices.

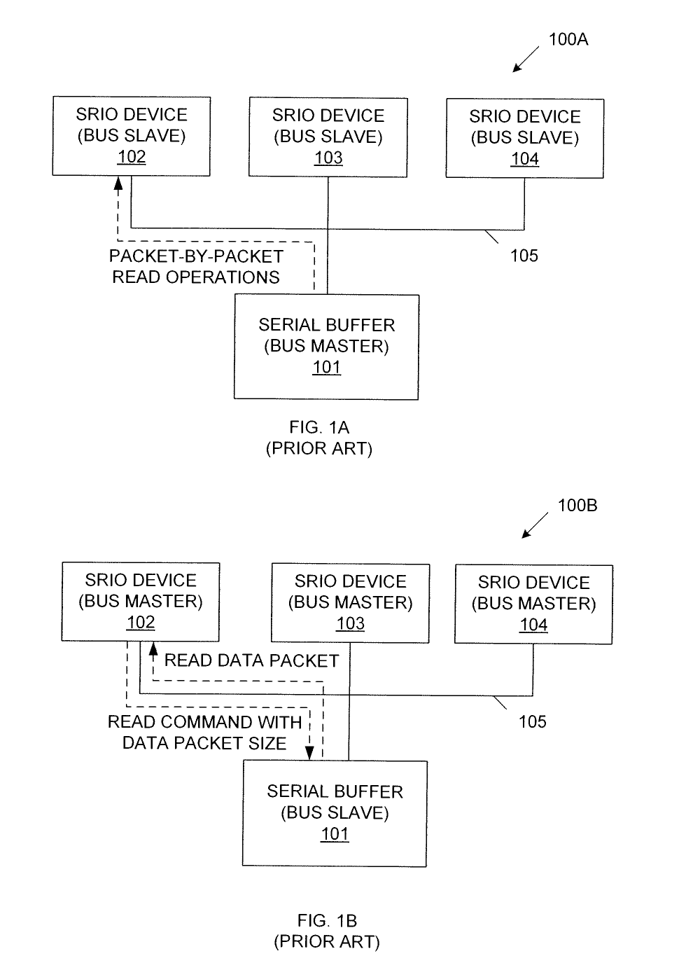

FIG. 2 is a block diagram of an SRIO system in accordance with one embodiment of the present invention.

FIG. 3 is a block diagram of a doorbell frame request control circuit, which is included in the serial buffer of FIG. 2 in accordance with one embodiment of the present invention.

FIG. 4 is a flow diagram that illustrating the manner in which the command decoder/sequencer of FIG. 3 initiates a read access in accordance with one embodiment of the present invention.

FIG. 5 is a flow diagram that illustrates the manner in which the queue read controller 302 implements a read access in accordance with one embodiment of the present invention.

### DETAILED DESCRIPTION

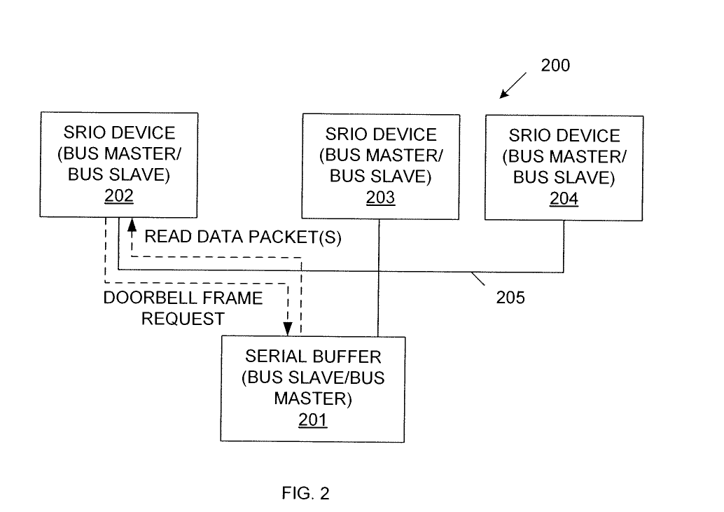

FIG. 2 is a block diagram of an sRIO system 200 in accordance with one embodiment of the present invention.

SRIO system 200 includes serial buffer 201, sRIO devices 202-204 and SRIO bus 205. Although three sRIO devices 202-204 are connected to sRIO bus 205, it is understood that other numbers of sRIO devices can be connected to sRIO bus 205 in other embodiments. Serial buffer 201 is configured to receive and transmit both data packets and priority packets via sRIO bus 205. The priority packets received by serial buffer 201 may specify various actions or commands to be implemented by serial buffer 201. The data packets received by serial buffer 201 may be stored in a plurality of queues within serial buffer 201.

In accordance with one embodiment of the present invention, sRIO system 200 is configured to implement a ‘doorbell frame request’ operation. In general, the ‘doorbell frame request’ operation is initiated by one of the sRIO devices 202-204 by transmitting a priority packet to serial buffer 201. At point in the operation, the sRIO device is configured as a bus master, and the serial buffer 201 is configured as a bus slave. The priority packet transmitted by the accessing sRIO device is coded to specify a read access to a selected queue of serial buffer 201. Serial buffer 201 decodes the received priority packet to determine that a ‘doorbell frame request’ operation has been specified. In response, serial buffer 201 operates as a bus master to transmit one or more data packets from the selected queue to the requesting SRIO device. Advantageously, the requesting SRIO device does not need to specify the size of the data packet(s) being read from serial buffer 201. As described below, minimal modifications are required within serial buffer 201 to enable the ‘doorbell frame request’ to be supported along with other general purpose doorbell requests conventionally available within sRIO system 200.

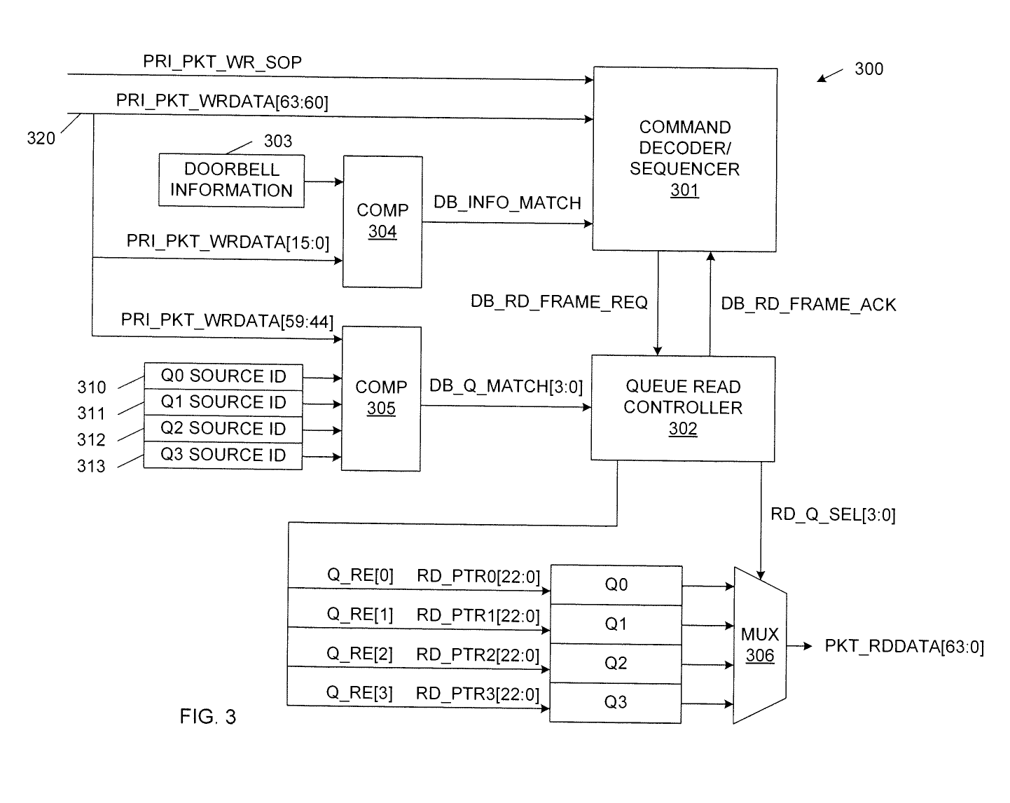

FIG. 3 is a block diagram of a doorbell frame request control circuit 300, which is included in serial buffer 201 in accordance with one embodiment of the present invention. Doorbell frame request control circuit 300 includes command decoder/sequencer 301, queue read controller 302, doorbell information register 303, comparators 304-305, multiplexer 306, queue source identifier registers 310-313, priority packet bus 320 and queues Q0-Q3. In addition to the functions described below, command decoder/sequencer 301 is also configured to service other conventional doorbell commands within serial buffer 201.

Queue read controller 302 controls read accesses to queues Q0-Q3 by controlling queue read enable signals Q_RE[3:0], queue read select signals RD_Q_SEL[3:0], and queue read pointer values RD_PTR0[22:0], RD_PTR1[22:0], RD_PTR2[22:0] and RD_PTR3[22:0]. Queue read enable signals Q_RE[3:0] are activated to enable data to be read from queues Q0-Q3, respectively. Queue read pointer values RD_PTR0[22:0], RD_PTR1[22:0], RD_PTR2[22:0]and RD_PTR3[22:0] provide read addresses for read operations to queues Q0, Q1, Q2 and Q3, respectively. Queue read select signals RD_Q_SEL[3:0] are activated to cause multiplexer 306 to route data read from queues Q3-Q0, respectively. The queue read data routed by multiplexer 306 is labeled PKT_RDDATA[63:0]. Note that queue read controller 302 can be used to retrieve data stored in queues Q0-Q3 to implement functions other than the ‘doorbell frame request’ operation described herein.

Priority packet bus 320 is configured to receive priority packets transmitted to serial buffer 201 (via sRIO bus 205). In the described examples, each priority packet includes a 64-bit double-word, which is labeled PRI_PKT_WRDATA[63:0]. The first four bits of this double-word (i.e., PRI_PKT_WRDATA[63:60]) is a packet type identifier field, which is used to identify the ‘type’ of the priority packet. In accordance with the described examples, all doorbell messages are identified by a packet type identifier field having a value of ‘1010’. These doorbell messages include, but are not limited to, a ‘doorbell frame request’ message. Thus, upon receiving a priority packet with PRI_PKT_WRDATA[63:60]=‘1010’, command decoder/sequencer 301 identifies the associated priority packet as a doorbell message (which may or may not be a ‘doorbell frame request’ message).

In the described examples, the 16 least significant bit locations of the received priority packet (i.e., PRI_PKT_WRDATA[15:0]) form an information field of the received priority packet. The 16-bit value stored in this information field is applied to comparator 304. Comparator 304 also receives a 16-bit doorbell information value stored in doorbell information register 303. If the received priority packet is a ‘doorbell frame request’ message, the corresponding information field (PRI_PKT_WRDATA[15:0]) of this priority packet is selected to match the doorbell information value stored in doorbell information register 303. Comparator 304 will therefore detect a match when the received priority packet is a ‘doorbell frame request’ message. Upon detecting a match, comparator 304 activates a match control signal, DB_INFO_MATCH, which is provided to command decoder/sequencer 301.

Bit locations [59:44] of the received priority packet (i.e., PRI_PKT_WRDATA[59:44]) are designated to store a destination identification value, which identifies the ‘destination’ of the received priority packet. If the received priority packet is a ‘doorbell frame request’ message, then the ‘destination’ of the priority packet is the queue to be read in serial buffer 201. In this case, the destination identification value of the received priority packet is selected to correspond with a source identification value assigned to the queue to be accessed. The unique source identification values associated with queues Q0-Q3 are stored in source identification registers 310-313, respectively. Comparator 305 compares the destination identification value of the received priority packet with each of the source identification values assigned to queues Q0-Q3. Upon detecting a match between the destination identification value of the received priority packet and one of the source identification values assigned to queues Q0-Q3, comparator 305 activates a corresponding queue match control signal. In the described example, comparator 305 provides four queue match control signals DB_Q_MATCH[0], DB_Q_MATCH[1], DB_Q_MATCH[2] and DB_Q_MATCH[3], which correspond with queues Q0, Q1, Q2 and Q3, respectively. For example, if the destination identification value associated with the received priority packet matches the source identification value assigned to queue Q2, comparator 305 will activate the queue match control signal DB_Q_MATCH[2] (while queue match control signals DB_Q_MATCH[0], DB_Q_MATCH[1] and DB_Q_MATCH[3] all remain de-activated). The queue match control signals DB_Q_MATCH[3:0] are provided to queue read controller 302 to indicate which one of the queues Q0-Q3 should be read during the corresponding ‘doorbell frame request’ operation.

Command decoder/sequencer 301 is also configured to receive a control field of the received priority packet, which includes a start-of-packet identifier (PRI_PKT_WR_SOP), which is activated to confirm the start/validity of the associated priority packet.

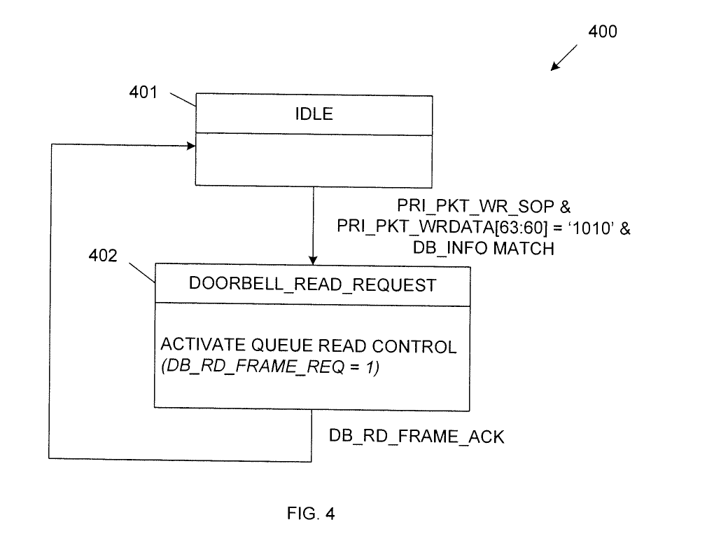

FIG. 4 is a flow diagram 400 illustrating the manner in which command decoder/sequencer 301 operates in response to the received signals. Command decoder/sequencer 301 is initially in an IDLE state 401. Upon detecting that the packet type of the received priority packet corresponds with a doorbell message (PRI_PKT_WRDATA[63:60]=‘1010’), that the DB_INFO_MATCH signal is activated, and that the start of packet identifier PRI_PKT_WR_SOP is activated, command decoder/sequencer 301 transitions from IDLE state 401 to DOORBELL_READ_REQUEST state 402. In DOORBELL_READ_REQUEST state 402, command decoder/sequencer 301 activates queue read controller 302, by activating a doorbell read frame request signal (DB_RD_FRAME_REQ=1). Command decoder/sequencer 301 remains in DOORBELL_READ_REQUEST state 402 until queue read controller 302 activates a doorbell read frame acknowledge signal (DB_RD_FRAME_ACK) to indicate that all of the requested data packets have been read from the selected queue. When queue read controller 302 activates the doorbell read frame acknowledge signal (DB_RD_FRAME_ACK), command decoder/sequencer 301 returns to IDLE state 401.

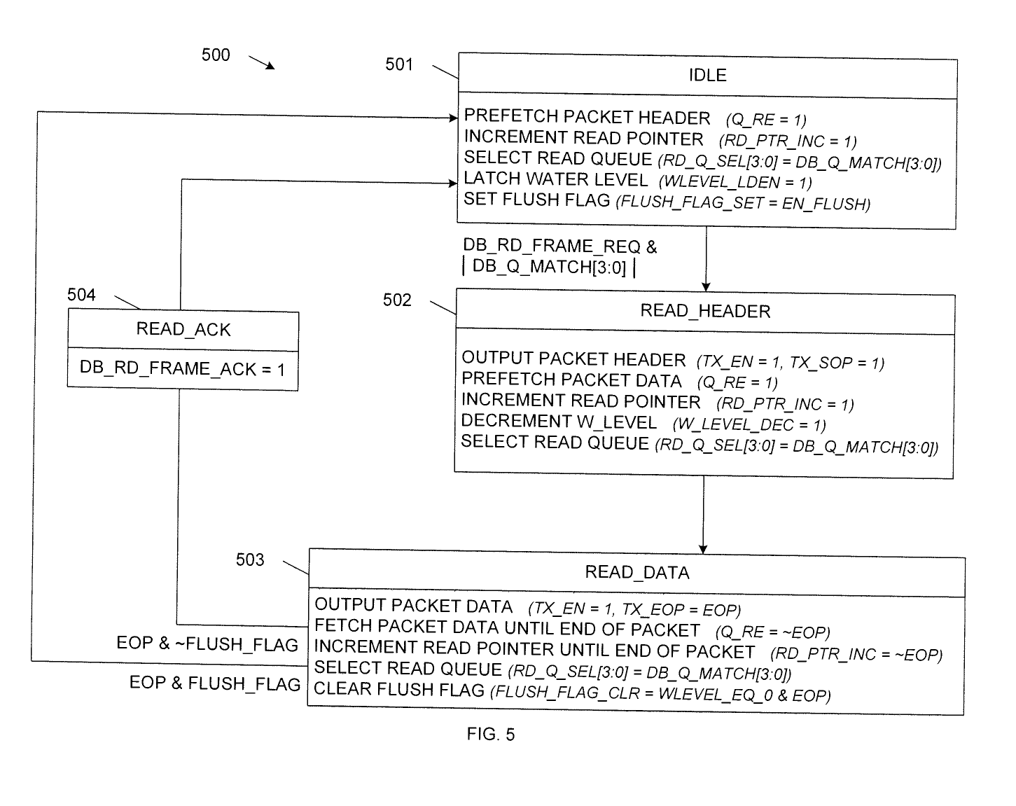

FIG. 5 is a flow diagram 500 illustrating a read control process implemented by queue read controller 302 to read data packets from the selected queue in accordance with one embodiment of the present invention. Initially, queue read controller 302 begins operation in an IDLE state 501. While in the IDLE state 501, queue read controller 302 monitors the DB_RD_FRAME_REQ signal provided by command decoder/sequencer 301 and the DB_Q_MATCH[3:0]signals provided by comparator 305. Upon detecting that the DB_RD_FRAME_REQ signal has been activated, queue read controller 302 determines which one of the DB_Q_MATCH[3:0] signals is activated, thereby identifying which one of queues Q0-Q3 will be read during the associated doorbell frame request operation. The queue to be read during the associated doorbell frame request operation is hereinafter referred to as the ‘selected’ queue.

Processing will then proceed as described below, as long as the selected queue has a higher priority than any other queue presently scheduled to be serviced.

Queue read control 302 generates a queue read select signal RD_Q_SEL[3:0], which causes multiplexer 306 to route the data values read from the selected queue.

Queue read controller 302 accomplishes this by setting the queue read select signal RD_Q_SEL[3:0] equal to the doorbell queue match signal, DB_Q_MATCH[3:0].

Queue read controller 302 also asserts a queue read enable signal associated with the selected queue (Q_RE=1), thereby causing a packet header to be read (pre-fetched) from the selected queue. The read pointer of the selected queue is initially set to access the packet header of a first data packet stored in the selected queue. After the packet header has been pre-fetched, queue read controller 302 increments the read pointer of the selected queue by activating an associated read counter increment signal (RD_PTR_INC=1). At this time, the read pointer points to the first data value of the first data packet in the selected queue.

In accordance with one embodiment of the present invention, data packets can be read from the selected queue in a flush mode or a non-flush mode. In the flush mode, all data packets up to the latched water level of the selected queue are read. In the non-flush mode, a single data packet is read from the selected queue. The serial buffer 201 stores an enable flush mode signal (EN_FLUSH) for each of the queues Q0-Q3. Each enable flush mode signal may be activated (EN_FLUSH=1) to enable the flush mode for the associated queue, or de-activated (EN_FLUSH=0) to enable the non-flush mode for the associated queue. The serial buffer 201 also stores a flush flag (FLUSH_FLAG) for each of the queues Q0-Q3, wherein each flush flag identifies whether the flush mode or non-flush mode is enabled for the corresponding queue. Initially, each flush flag is reset (FLUSH_FLAG=0), thereby enabling the non-flush mode in each of the queues.

Queue read controller 302 causes a flush flag set signal (FLUSH_FLAG_SET) associated with the selected queue to be activated if the flush mode is activated (EN_FLUSH=1) for the selected queue. The activated flush flag set signal causes the flush flag to be set (FLUSH_FLAG=1) for the selected queue. Queue read controller 302 does not activate the flush flag set signal if the flush mode is not activated (EN_FLUSH=0) for the selected queue. In this case, the flush flag of the selected queue remains in the initial reset state (FLUSH_FLAG=0).

Queue read controller 302 also latches the water level (WLEVEL) of the selected queue by activating a water level load enable signal (WLEVEL_LDEN=1) associated with the selected queue. As mentioned above, the latched water level of the selected queue is required if the flush mode is enabled.

Processing then proceeds from IDLE state 501 to READ_HEADER state 502. Within READ_HEADER state 502, queue read controller 302 enables a transmit enable signal (TX_EN=1) and a transmit start-of-packet signal (TX_SOP=1), thereby causing the packet header pre-fetched in the IDLE state 501 to be transmitted to the requesting sRIO device via sRIO bus 205.

Also in the READ_HEADER state 502, queue read controller 302 asserts the queue read enable signal (Q_RE=1) associated with the selected queue, thereby causing the first data value of the first data packet to be read (pre-fetched) from the selected queue. After this first data value has been pre-fetched, queue read controller 302 increments the read pointer of the selected queue by activating the corresponding read pointer increment signal (RD_PTR_INC=1), such that this read pointer points to the second data value of the first data packet.

Before leaving the READ_HEADER state 502, queue read controller 302 decrements the latched water level value (WLEVEL) associated with the selected queue by activating a water level decrement signal (WLEVEL_DEC=1) associated with the selected queue. By decrementing the latched water level value each time that a packet header is read from the selected queue, queue read controller 302 maintains a running count of the remaining number of data packets to be read from the selected queue. Also before leaving the READ_HEADER state 502, queue read controller 302 ensures that the queue read select signal RD_Q_SEL[3:0] signal is equal to the doorbell queue match signal, DB_Q_MATCH[3:0].

Processing proceeds from READ_HEADER state 502 to READ_DATA state 503. Within READ_DATA state 503, queue read controller 302 enables the transmit enable signal (TX_EN=1), thereby causing the first data value pre-fetched in the READ_HEADER state 502 to be transmitted to the requesting sRIO device 202 via sRIO bus 205. In addition, queue read controller 302 extracts an end-of-packet identifier (EOP) from the first data value. This end-of-packet identifier is de-activated (EOP=0) if the first data value is not the last data value of the associated data packet. Conversely, this end-of-packet identifier is activated (EOP=1) if the first data value is the last data value of the associated data packet. A transmit end-of-packet signal is set equal to the end of packet identifier (TX_EOP=EOP).

If the first data value is not the last data value of the associated packet (EOP=0), processing queue read controller 302 reads the next (i.e., second) data value from the selected queue (i.e., from the location identified by the previously incremented read pointer. In the described embodiment, queue read controller 302 implements this read operation by setting the queue read enable signal of the selected queue equal to the inverse of the end-of-packet identifier (Q_RE=˜EOP).

Upon reading the next (second) data value from the selected queue, queue read controller 302 increments the read pointer to point to the next (third) address of the selected queue. In the described embodiment, queue read controller 302 increments this read pointer by setting the corresponding read pointer increment control signal equal to the inverse of the end-of-packet identifier (RD_PTR_INC=˜EOP). Queue read controller 302 also ensures that the queue read select signal RD_Q_SEL[3:0] signal is set equal to the doorbell queue match signal, DB_Q_MATCH[3:0].

The above-described steps of the READ_DATA state 503 are repeated, thereby sequentially reading data values of the first data packet from the selected queue and incrementing the associated read pointer, until the end-of-packet identifier of the data value transmitted to the requesting sRIO device identifies the end of the first data packet (i.e., EOP=1). In response to the activated end-of-packet identifier of the first data packet, queue read controller 302 deactivates the queue read enable signal of the selected queue and the associated read pointer increment signal (Q_RE=RD_PTR_INC=˜EOP=0). At this time, the read pointer points to the packet header of the next data packet in the selected queue.

Upon detecting the activated end-of-packet identifier associated with the first data packet, queue read controller 302 will activate a clear control signal (FLUSH_FLAG_CLR=1) to reset the flush flag (FLUSH_FLAG=0) associated with the selected queue if the latched water level value of the selected queue has been reduced to zero (WLEVEL=0). In accordance with one embodiment, when the latched water level value is reduced to zero, a corresponding control signal is activated (WLEVEL_EQ_{—}0=1). This control signal is logically AND'ed with the end-of-packet indicator EOP to generate the signal used to clear the flush flag (i.e., FLUSH_FLAG_CLR=WLEVEL_EQ_{—}0 & EOP).

Also upon detecting the activated end-of-packet identifier associated with the first data packet,

queue read controller 302 exits READ_DATA state 503 and either returns to IDLE state 501, or proceeds to READ_ACK state 504. More specifically, processing returns to IDLE state 501 if the associated flush flag is set (FLUSH_FLAG=1), or processing proceeds to READ_ACK state 504 if the associated flush flag is reset (FLUSH_FLAG=0).

If the associated flush flag is set upon receiving the end of packet identifier, this means that the flush mode is enabled in the selected queue, but not all of the data packets in the latched water level have been read out of the selected queue. In this case, processing returns to IDLE state 501, so that another data packet can be read from the selected queue, as processing again proceeds through states 501-503. As described above in connection with READ_HEADER state 502, reading another data packet from the selected queue will decrement the associated latched water level value. This loop is repeated until the latched water level value reaches zero, thereby clearing the associated flush flag, and causing processing to proceed from READ_DATA state 503 to READ_ACK state 504.

Note that if the associated flush flag is not initially set (i.e., the non-flush mode is enabled), then this flush flag will be in the reset state after the first data packet is read from the selected queue. In this case, processing will proceed from READ_DATA state 503 to READ_ACK state 504 after the first data packet is read from the selected queue.

In READ_ACK state 504, queue read controller 302 activates the doorbell read frame acknowledge signal (DB_RD_FRAME_ACK=1) to indicate that the read access of the selected queue is complete. The activated doorbell read frame acknowledge signal is provided to command decoder/sequencer 301, thereby causing the command decoder/sequencer 301 to return to an IDLE state 401 (FIG. 4). Upon activating the doorbell read frame acknowledge signal, queue read controller 302 causes processing to return to IDLE state 501.

In accordance with one embodiment of the present invention, queue read controller 302 may determine that the packet header retrieved in IDLE state 501 does not include a valid start-of-packet indicator, thereby indicating that the selected queue is empty. In this case, processing proceeds directly from IDLE state 501 to READ_ACK state 504. In response, command decoder/sequencer 301 determines that the doorbell read frame acknowledge signal (DB_RD_FRAME_ACK) has been activated before any packet data has been transmitted to the requesting sRIO device. Under these conditions, command decoder/sequencer 301 generates a ‘read exceed’ packet, which is transmitted to the requesting sRIO device to indicate that the corresponding doorbell frame request has attempted to access an empty queue.

In the foregoing manner, any one of the sRIO devices 202-204 may transmit a doorbell frame request message to serial buffer 201 to access packet data stored in a selected queue of serial buffer 201. The requesting sRIO device does not need to specify the size of the packet data to be retrieved from serial buffer 201. Upon recognizing a received doorbell frame request message, serial buffer 201 operates as a master to retrieve packet data from the selected queue, and transmit this retrieved packet data to the requesting sRIO device.

Although the present invention has been described in connection with various embodiments, it is understood that variations of these embodiments would be obvious to one of ordinary skill in the art. Thus, the present invention is limited only by the following claims.

We claim:

1. A serial buffer comprising:
a bus configured to receive packets from an external device configured as a bus master, wherein the packets include a doorbell frame request packet that requests a read access to a memory of the serial buffer;
a decoder circuit configured to receive and identify the doorbell frame request packet received by the bus; and
a read controller configured to initiate a read access to the memory of the serial buffer in response to the decoder circuit identifying the doorbell frame request packet, wherein the read controller operates as a bus master to read one or more data packets from the memory, for transmission to the external device.

2. The serial buffer of claim 1, wherein the packets received on the bus comprise priority packets, which specify various actions and commands to be implemented by the serial buffer.

3. The serial buffer of claim 1, wherein the doorbell frame request packet includes a destination field that contains a destination identification value that identifies the memory of the serial buffer.

4. The serial buffer of claim 3, wherein the decoder circuit includes:
one or more source identification registers that store one or more corresponding source identification values associated with one or more corresponding memories of the serial buffer; and
a comparator configured to compare each of the one or more source identification values with the destination identification value, and activate a corresponding memory match signal if the destination identification value matches one of the source identification values.

5. The serial buffer of claim 1, wherein the decoder circuit includes a command decoder configured to identify the doorbell frame request packet as a doorbell command.

6. The serial buffer of claim 1, wherein each of the received packets includes a doorbell information field wherein the doorbell information field of the doorbell frame request packet contains a predetermined doorbell frame request identification value.

7. The serial buffer of claim 6, wherein the decoder circuit includes:
a doorbell information register configured to store a doorbell information value equal to the predetermined doorbell frame request identification value; and
a comparator configured to compare the doorbell information field of each of the received packets with the doorbell information value, and activate a corresponding doorbell information match signal if the doorbell information field matches the doorbell information value.

8. The serial buffer of claim 1, wherein the read controller is configured to operate in a non-flush mode, wherein a single data packet is read out of the memory by the read access.

9. The serial buffer of claim 1, wherein the read controller is configured to operate in a flush mode, wherein a water level of the memory is determined upon initiating the read access, and one or more data packets are read from the memory, such that all data packets in the memory below the water level are read.

10. The serial buffer of claim 1, wherein a size of the one or more data packets read from the memory is not specified by the external device.

11. A method of operating a serial buffer comprising:
receiving packets from an external device configured as a bus master, wherein the packets include a doorbell frame request packet that requests a read access to a memory of the serial buffer, without specifying a size of the read access;
decoding the received packets with the serial buffer to identify the doorbell frame request packet; and
initiating a read access to the memory of the serial buffer in response to identifying the doorbell frame request packet, wherein the serial buffer operates as a master to perform the read access of the memory, such that one or more complete data packets are read from the memory and provided to the external device.

12. The method of claim 11, wherein the received packets comprise priority packets, which specify various actions and commands to be implemented by the serial buffer.

13. The method of claim 11, further comprising selecting the memory of the serial buffer to be the subject of the read access by comparing one or more source identification values associated with one or more corresponding memories of the serial buffer with a destination identification value of the doorbell frame request packet.

14. The method of claim 11, wherein the step of decoding comprises determining that a first field of the doorbell frame request packet identifies a doorbell command.

15. The method of claim 11, wherein the step of decoding comprises:
defining a doorbell information field in each of the received packets, wherein the doorbell information field of the doorbell frame request packet contains a predetermined doorbell frame request identification value;
storing a doorbell information value equal to the predetermined doorbell frame request identification value with the serial buffer; and
comparing the doorbell information fields of the received packets with the doorbell information value, and identifying the doorbell frame request command if the doorbell information field matches the doorbell information value.

16. The method of claim 11, further comprising reading a single data packet is read out of the memory in response to the doorbell frame request packet.

17. The method of claim 11, further comprising:
latching a water level of the memory upon initiating the read access; and
reading one or more data packets from the memory, such that all data packets below the latched water level of the memory are read in response to the doorbell frame request packet.

18. The method of claim 11, further comprising:
determining whether the memory is empty upon initiating the read access; and
informing the external device that the memory is empty in response to determining that the memory is empty.
